(19) United States
(12) Patent Application Publication
(10) Pub. No.: US 2025/0265930 A1
(43) Pub. Date: Aug. 21, 2025

(54) INFORMATION PROCESSING DEVICE, METHOD, AND PROGRAM

(71) Applicant: TOYOTA JIDOSHA KABUSHIKI KAISHA, Toyota-shi, Aichi (JP)

(72) Inventors: Toshiki SHINOHARA, Toyota-shi (JP); Masataka OKUDA, Toyota-shi (JP); Masatoshi KAKUTANI, Miyoshi-shi (JP); Kaoru YOSHIDA, Nisshin-shi (JP); Kanade KURIYAMA, Toyota-shi (JP)

(73) Assignee: TOYOTA JIDOSHA KABUSHIKI KAISHA, Toyota-shi, Aichi (JP)

(21) Appl. No.: 19/106,410

(22) PCT Filed: Aug. 8, 2023
(86) PCT No.: PCT/JP2023/028931

§ 371 Date: Feb. 25, 2025

(30) Foreign Application Priority Data
Oct. 13, 2022 (JP) 2022-164974
Dec. 12, 2022 (JP) 2022-198003

(51) Int. Cl. G08G 1/16; G08G 1/01; G08G 1/052

(52) U.S. Cl. CPC G08G 1/164; G08G 1/0112; G08G 1/0125; G08G 1/0141; G08G 1/052; G08G 1/166

(57) ABSTRACT

An information processing device (100) can improve the completeness of a traffic digital twin (130) by controlling communication with a plurality of objects (200). The information processing device (100) includes: a communication unit (110) configured to acquire object data from the plurality of objects through the communication; a processing unit (120) configured to construct a traffic digital twin (130) synchronized in time with a real space, in a virtual space, based on the object data acquired by the communication unit (110); and a determination unit (140) configured to determine an object existence probability in an undetermined area where there is no object data in the traffic digital twin (130), based on the object data around the undetermined area, and notify the processing unit (120) of the determined object existence probability in the undetermined area.

### TECHNICAL FIELD

The present disclosure relates to an information processing device, etc., for controlling communication with a plurality of vehicles.

### BACKGROUND ART

Patent Literature 1 discloses a system in which a server receives, from a plurality of vehicles, digital data (vehicle data) that describes conditions of the vehicles and behaviors of the vehicles, and updates a traffic digital twin constructed within the server, based on the received vehicle data.

### CITATION LIST

### Patent Literature

[PTL 1] Japanese Laid-Open Patent Publication No. 2020-013557

### SUMMARY OF THE INVENTION

### Problems to be Solved by the Invention

In areas where there is no vehicle data, whether or not objects exist therein is unclear in some cases. If there are such areas where the existence of objects is unknown, the completeness of the traffic digital twin is decreased. Therefore, it is desirable to reduce the areas where the existence of objects is unknown and improve the completeness of the traffic digital twin.

The present disclosure has been made in view of the above problem, and an object of the present disclosure is to provide an information processing device, etc., that can improve the completeness of a traffic digital twin.

### Solution to the Problems

In order to achieve the above object, an aspect of this disclosed technology is an information processing device configured to control communication with a plurality of objects, the information processing device including: a communication unit configured to acquire object data from the plurality of objects through the communication; a processing unit configured to construct a traffic digital twin synchronized in time with a real space, in a virtual space, based on the object data acquired by the communication unit; and a determination unit configured to determine an object existence probability in an undetermined area where there is no object data in the traffic digital twin, based on the object data around the undetermined area, and notify the processing unit of the determined object existence probability in the undetermined area.

### Advantageous Effects of the Invention

The information processing device of the present disclosure can improve the completeness of the traffic digital twin.

### BRIEF DESCRIPTION OF THE DRAWINGS

FIG. 1 is a schematic configuration diagram of a digital twin system including an information processing device according to one embodiment of the present disclosure.

FIG. 2 is a flowchart of an object existence probability determination process executed by the information processing device.

FIG. 3 is an example of a correspondence map used in the object existence probability determination process.

FIG. 4 is an example of the correspondence map used in the object existence probability determination process.

FIG. 5 is an example of the correspondence map used in the object existence probability determination process.

FIG. 6 is a flowchart of a vehicle control instruction process executed by the information processing device.

FIG. 7 is a specific image diagram illustrating the vehicle control instruction process.

### DESCRIPTION OF EMBODIMENTS

If there is an undetermined area for which there is no direct data in a digital twin constructed from various data acquired from objects, the information processing device of the present disclosure determines an object existence probability in the undetermined area, based on data that can be acquired. The completeness of the digital twin can be improved by reflecting the determined object existence probability in the construction of the digital twin and complementing the undetermined area.

Hereinafter, an embodiment of the present disclosure will be described in detail with reference to the drawings.

### Embodiment

### [Configuration]

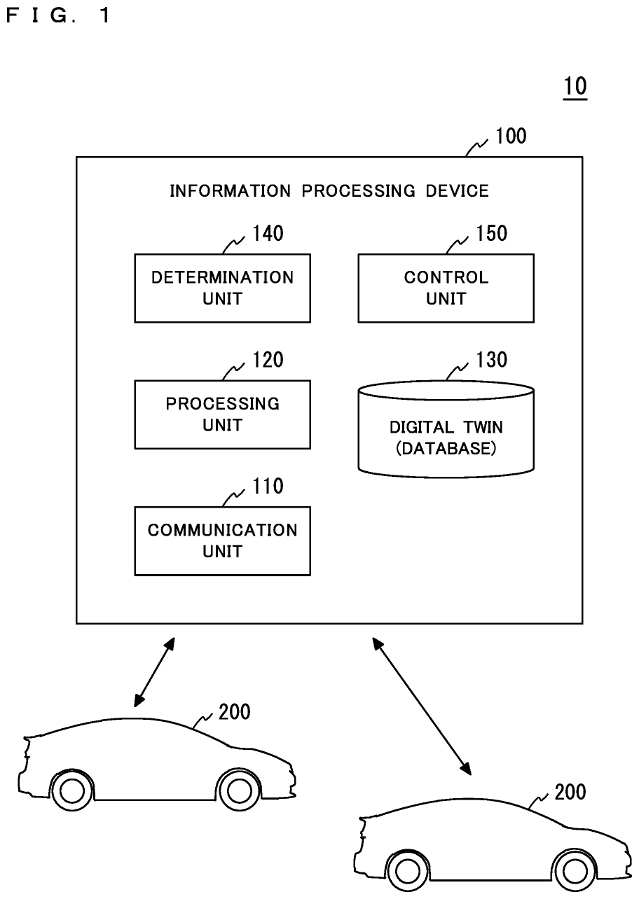

FIG. 1 is a schematic diagram showing an example of the overall configuration of a digital twin system 10 including an information processing device 100 according to one embodiment of the present disclosure. The digital twin system 10 illustrated in FIG. 1 is configured to include the information processing device 100 and a plurality of objects 200. The information processing device 100 and the plurality of objects 200 are connected either directly or via a communication base station, which is not shown, so as to enable communication therebetween.

The information processing device 100 is configured to be able to communicate with the plurality of objects 200. The information processing device 100 can provide, for example, a predetermined service to a specific object 200, based on object data including information about an object condition, etc., acquired from each of the plurality of objects 200. Examples of the objects 200 include mobile objects such as vehicles and smartphones. In the case where each object 200 is a vehicle, for example, a traffic control service can be provided to a specific vehicle 200 based on vehicle data including information about an own vehicle condition, etc., acquired from each of the plurality of vehicles 200. A cloud server configured in the cloud can be exemplified as the information processing device 100.

The information processing device 100 includes a communication unit 110, a processing unit 120, a digital twin 130, a determination unit 140, and a control unit 150. The information processing device 100 is typically configured to include a processor such as a central processing unit (CPU), a memory such as random access memory (RAM), a readable/writable storage medium such as a hard disk drive (HDD) or solid state drive (SSD), input/output interfaces, etc., and realizes all or part of functions executed by the communication unit 110, the processing unit 120, the determination unit 140, and the control unit 150, by the processor reading and executing a program stored in the memory.

The communication unit 110 is configured to execute communication with the plurality of objects 200 and receive (acquire), from the plurality of objects 200, object data including information about an object condition, data related to the generation of the digital twin 130, etc., and a communication request related to a predetermined service. In the case where each object 200 is a vehicle, the communication unit 110 executes communication with the plurality of vehicles 200 and receives (acquires), from each of the plurality of vehicles 200, vehicle data including the position, speed, traveling direction, etc., of the vehicle as information about an own vehicle condition, data about the surroundings of the vehicle and data related to communication quality as data related to the generation of the digital twin 130, etc., and a communication request related to a predetermined service. In addition, the communication unit 110 can transmit information, data, control instructions, etc., required for the predetermined service, to the object 200 that has transmitted the communication request among the plurality of objects 200.

The processing unit 120 performs overall control of the information processing device 100, including communication with the plurality of objects 200, management of the digital twin 130, etc. In particular, when constructing a traffic digital twin based on the digital twin 130, the processing unit 120 of the present embodiment takes into account or reflects an object existence probability in an undetermined area determined by the determination unit 140 described later, thereby improving the completeness of the traffic digital twin.

The digital twin 130 is a database for reproducing a virtual world (virtual space) synchronized in time with the real world (real space), on a cloud computer by updating in real time and storing data about current and past object conditions acquired (collected) from the plurality of objects 200. In the case where each object 200 is a vehicle, a traffic digital twin in which all objects (moving objects/stationary objects) on travelling paths and traffic conditions in locations (roads, parking lots, etc.) where vehicles participating in the digital twin system 10, including the plurality of vehicles 200, can travel are replicated can be generated in the digital twin 130. Examples of the information included in the data stored in the digital twin 130 include vehicle information (VIN, etc.), information about other vehicle traffic (including bicycles, pedestrians, etc.), map information, time information (time stamp), position information (GPS latitude/longitude), trajectory information (vehicle speed, direction, etc.) which is a traveling trajectory, etc.

If there is an “undetermined area” which is an area where there is no direct object data in the traffic digital twin constructed by the processing unit 120, the determination unit 140 determines an “object existence probability” indicating a probability that any object 200 will exist in the undetermined area. The object existence probability takes a value in the range of 0 to 100%, and is, for example, a parameter that gradually decreases during an estimated period of movement until the next time object data is received, with the maximum value of 100% being at a point at which the information processing device 100 receives object data from the object 200. The rate at which the object existence probability decreases can be individually determined according to the condition of each object 200, etc.

The control unit 150 derives the probability of a collision occurring between the plurality of objects 200, etc., based on the object existence probability of the traffic digital twin, and determines object control values to be instructed to the plurality of objects 200, based on the probability of the collision occurring, etc. The method for determining the object control value by the control unit 150 will be described later.

Each object 200 is a mobility such as a vehicle that is configured to be able to communicate with the information processing device 100. The object 200 can provide information about the object condition, data related to the generation of the digital twin 130 constructed in the information processing device 100, and a communication request related to a predetermined service to the information processing device 100 via a communication device which is not shown. In the case where each object 200 is a vehicle, the information about an own vehicle condition includes the position of the vehicle, the speed of the vehicle, the traveling direction of the vehicle, etc. In the case where each object 200 is a vehicle, the data about the generation of the digital twin 130 includes data about other vehicles, buildings, pedestrians, etc., that are objects existing around the vehicle 200, other than the own vehicle. Various sensors (not shown) installed in the object (vehicle) 200 can be used to acquire such information and data. The number of objects (vehicles) 200 that communicate with the information processing device 100 is not particularly limited.

### [Control]

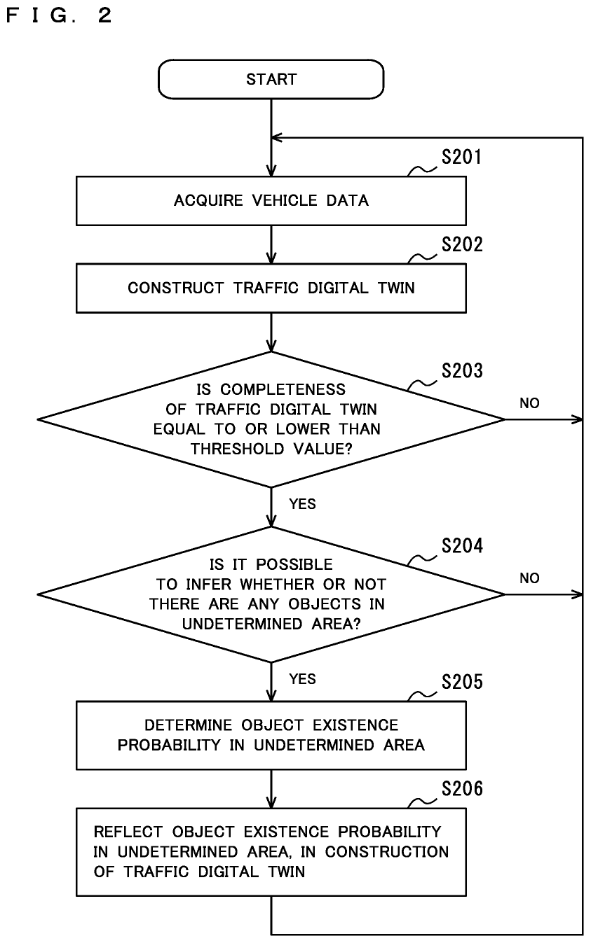

Next, control executed by the information processing device 100 according to the present embodiment will be described with further reference to FIG. 2 to FIG. 7. As processes performed by the information processing device 100, a process of determining an object existence probability in an undetermined area in the traffic digital twin and a process of instructing control of each vehicle 200 using an object existence probability for each vehicle 200 in the traffic digital twin, can be exemplified. Hereinafter, the features realized by the information processing device 100 will be described with the case where each object 200 is a vehicle as an example.

### (1) Object Existence Probability Determination Process

FIG. 2 is a flowchart illustrating the procedure of an object existence probability determination process executed by each component of the information processing device 100. The object existence probability determination process illustrated in FIG. 2 is started when the traffic digital twin is activated (constructed), and is repeatedly performed until the activation (construction) of the traffic digital twin ends, for example

### (Step S201)

The communication unit 110 of the information processing device 100 acquires vehicle data from each of the plurality of vehicles 200. This vehicle data may be requested by the information processing device 100 from the vehicle 200, based on a predetermined cycle, determination of a decrease in the completeness of the traffic digital twin, or the like, or may be transmitted to the information processing device 100 by the vehicle 200 at a predetermined cycle or predetermined timing (such as the occurrence of a specific event). The vehicle data acquired from the plurality of vehicles 200 is stored in the digital twin 130.

After the vehicle data is acquired by the communication unit 110 from the plurality of vehicles 200, the process proceeds to step S202.

### (Step S202)

The processing unit 120 of the information processing device 100 constructs a traffic digital twin based on the vehicle data acquired from the plurality of vehicles 200, by referring to the digital twin 130. A known method can be used to construct the traffic digital twin. In addition to this known method, the information processing device 100 of the present embodiment is characterized by taking into account or reflecting an object existence probability in an undetermined area determined in step S205 described later in the construction of the traffic digital twin.

After the traffic digital twin is constructed by the processing unit 120, the process proceeds to step S203.

### (Step S203)

The processing unit 120 of the information processing device 100 determines whether the completeness of the constructed traffic digital twin is equal to or lower than a predetermined threshold value. This determination is performed in order to determine whether or not a level at which the constructed traffic digital twin can be used for a traffic control service to the vehicle 200 has been reached. Thus, the predetermined threshold value is set appropriately based on whether or not the traffic digital twin can ensure a level at which remote control of the vehicle 200 can be performed safely and securely, etc.

If the processing unit 120 determines that the completeness of the traffic digital twin is equal to or lower than the predetermined threshold value (YES in step S203), the process proceeds to step S204. On the other hand, if the processing unit 120 determines that the completeness of the traffic digital twin exceeds the predetermined threshold value (NO in step S203), the process proceeds to step S201.

### (Step S204)

If there is an undetermined area which is an area where there is no direct vehicle data in the traffic digital twin constructed by the processing unit 120, the determination unit 140 of the information processing device 100 determines whether or not it is possible to infer whether or not there are any objects in the undetermined area. The following three methods can be exemplified as methods for inferring whether or not there are any objects in the undetermined area.

a. Method Using Inter-Vehicle Distance

The case where the area between a certain vehicle (forward vehicle) and a vehicle (rear vehicle) following the forward vehicle is an undetermined area, is considered. In this case, for example, if the inter-vehicle distance between the forward vehicle and the rear vehicle is shorter than the size of a specific vehicle (e.g. a light passenger car), it is possible to determine that there is no other mobile object such as another vehicle in this undetermined area. On the other hand, for example, if the inter-vehicle distance between the forward vehicle and the rear vehicle is longer than the size of a specific vehicle (e.g., a bus or truck), it can be inferred that there is a possibility that there is another mobile object such as another vehicle in this undetermined area.

Therefore, with this method using the inter-vehicle distance, if a state where the forward vehicle and the rear vehicle located in front of and behind the undetermined area maintain a predetermined inter-vehicle distance (e.g. 4 m to 6 m) has continued for a predetermined period of time (e.g. 10 seconds), it can be determined that it is possible to infer whether or not there are any objects in the undetermined area.

In the case where the forward vehicle and/or the rear vehicle is equipped with a millimeter wave radar or the like, whether or not there are any vehicles behind the forward vehicle and/or in front of the rear vehicle can be grasped by detection of the millimeter wave radar. In this case, the inter-vehicle distance between the forward vehicle and the rear vehicle at which it is determined that it is possible to infer whether or not there are any objects in the undetermined area can be increased as compared to when a millimeter wave radar or the like is not installed.

b. Method Using Distance from Stop Line

The case where there is an undetermined area at a specific location where a stop line is drawn, such as at a signalized intersection or a railroad crossing, is considered. In this case, for example, if a traveling vehicle stops at a position close to the stop line, it can be determined that there is no mobile object such as another vehicle between the center of the intersection and the vehicle or between the railroad and the vehicle in this undetermined area. On the other hand, for example, if a traveling vehicle stops at a position far from the stop line, it can be inferred that there is a possibility that there is another mobile object such as another vehicle in this undetermined area.

Therefore, with this method using the distance from the stop line, if the distance from the stop line to the vehicle in the undetermined area at the specific location is within a predetermined distance (e.g. 4 m to 6 m), it can be determined that it is possible to infer whether or not there are any objects in the undetermined area.

c. Method Using Vehicle Avoidance Action

The case where there is an undetermined area where traveling vehicles are taking avoidance action by performing a steering operation such as changing a lane, is considered. In this case, for example, if the number of vehicles that have taken avoidance action is small, or if the period during which a plurality of vehicles have taken avoidance action is short, it can be determined that there is no stationary object such as a building or a parked vehicle in this undetermined area. On the other hand, for example, if the number of vehicles that have taken avoidance action is large, or if the period during which a plurality of vehicles have taken avoidance action is long (continuing), it can be determined that there is a stationary object such as a building or a parked vehicle in this undetermined area.

Therefore, with this method using the vehicle avoidance action, if the number of vehicles taking avoidance action in the undetermined area is equal to or larger than a predetermined number, and the avoidance action taken by vehicles is continued for a predetermined period of time, it can be determined that it is possible to infer whether or not there are any objects in the undetermined area.

If the determination unit 140 determines that it is possible to infer whether or not there are any objects in the undetermined area (YES in step S204), the process proceeds to step S205. On the other hand, if the determination unit 140 determines that it is impossible to infer whether or not there are any objects in the undetermined area (NO in step S204), the process proceeds to step S201.

### (Step S205)

The determination unit 140 of the information processing device 100 determines an object existence probability in the undetermined area. The determination unit 140 determines this object existence probability in the undetermined area, for example, as follows.

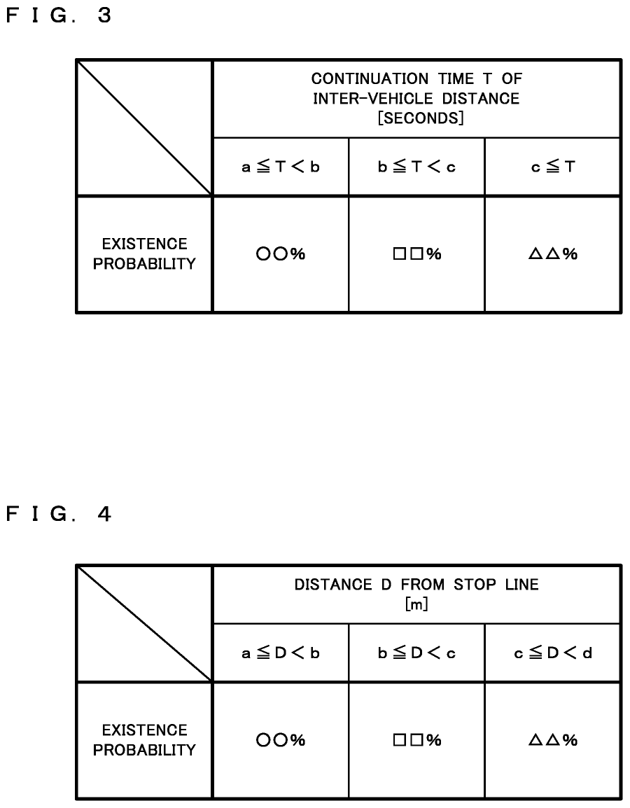

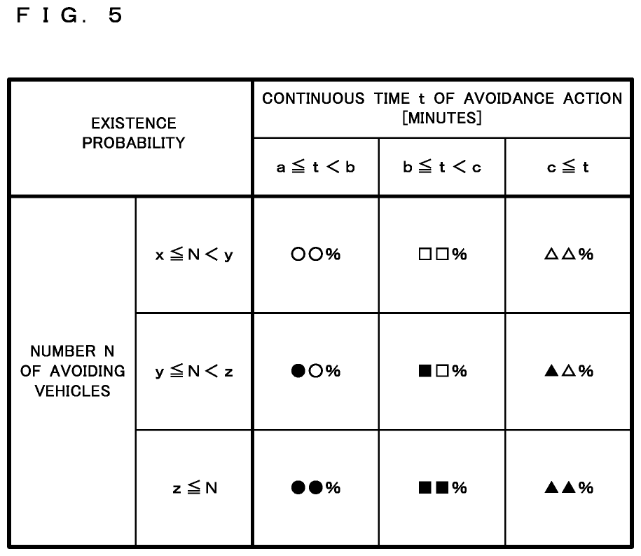

In the case of the above-described method using the inter-vehicle distance, for example, using a correspondence map shown in FIG. 3, the object existence probability in the undetermined area can be determined according to a time T during which a state where the inter-vehicle distance is maintained is continuing. In the case of the above-described method using the distance from the stop line, for example, using a correspondence map shown in FIG. 4, the object existence probability in the undetermined area can be determined according to a distance D from the stop line to a position at which the vehicle has stopped. In the case of the above-described method using the vehicle avoidance action, for example, using a correspondence map shown in FIG. 5, the object existence probability in the undetermined area can be determined according to the number N of vehicles that have taken avoidance action and a time t for which the avoidance action is continuously performed.

Such a correspondence map can be created in advance based on past results of determining individual characteristics and the features of road environments by AI or the like. In addition, the inter-vehicle distance, etc., change dynamically depending on the traveling conditions (day/night, weather, etc.), and thus a plurality of correspondence maps may be prepared in advance for various traveling conditions.

After the object existence probability in the undetermined area is determined by the determination unit 140, the process proceeds to step S206.

### (Step S206)

The determination unit 140 of the information processing device 100 reflects the determined object existence probability in the undetermined area, in the construction of the traffic digital twin. This reflection is performed, for example, by the determination unit 140 notifying the processing unit 120 of the determined object existence probability in the undetermined area.

After the object existence probability in the undetermined area is reflected by the determination unit 140 in the construction of the traffic digital twin, the process proceeds to step S201.

With the object existence probability determination process, the object existence probability in the undetermined area in the traffic digital twin can be effectively inferred, so that the completeness of the traffic digital twin can be improved by taking into account or reflecting the object existence probability in the construction of the traffic digital twin.

### (2) Vehicle Control Instruction Process

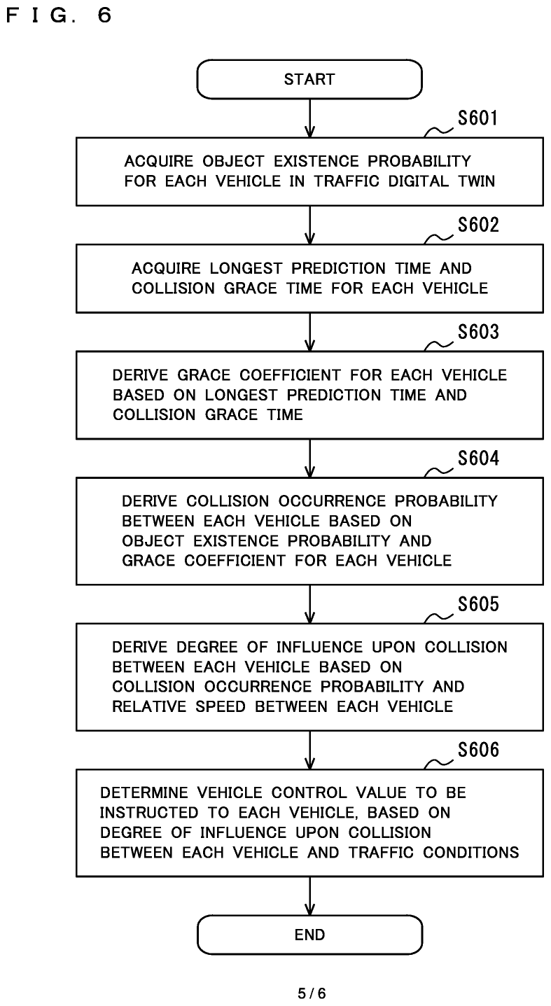

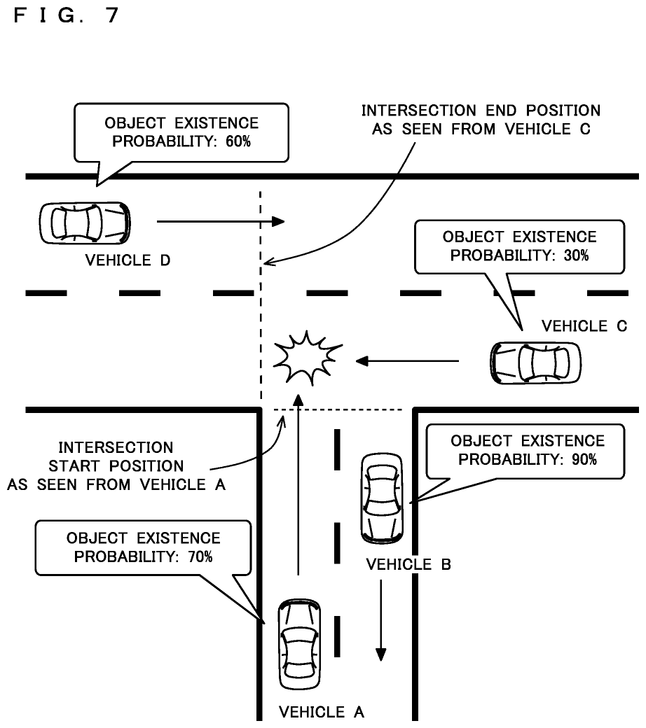

FIG. 6 is a flowchart illustrating the procedure of a vehicle control instruction process executed by the control unit 150 of the information processing device 100. FIG. 7 is a specific image diagram for describing the vehicle control instruction process in an easy-to-understand manner. The vehicle control instruction process illustrated in FIG. 6 is started, for example, when the timing to instruct a vehicle control value related to traffic control to a target vehicle 200 comes.

### (Step S601)

The control unit 150 of the information processing device 100 refers to the digital twin 130 and acquires an object existence probability for each vehicle 200 in the traffic digital twin. In the example in FIG. 7, the control unit 150 acquires 70% as an object existence probability for a vehicle A, 90% as an object existence probability for a vehicle B, 30% as an object existence probability for a vehicle C, and 60% as an object existence probability for a vehicle D.

After the object existence probability for each vehicle 200 in the traffic digital twin is acquired by the control unit 150, the process proceeds to step S602.

### (Step S602)

The control unit 150 of the information processing device 100 acquires a longest prediction time and a collision grace time for each vehicle 200 in the traffic digital twin. Here, the longest prediction time is the longest time for which one or more applications that provide traffic control services or the like to each vehicle 200 can predict the behavior of the vehicle 200. The collision grace time is the time that is predicted to be taken until a certain vehicle 200 collides with another vehicle 200, by the one or more applications that provide traffic control services or the like to each vehicle 200. The longest prediction time and the collision grace time are variable values that fluctuate depending on the speed of the vehicle 200, and are determined in advance by each application. The one or more applications that provide traffic control services or the like can be configured within the information processing device 100 or in the cloud outside the information processing device 100.

After the longest prediction time and the collision grace time for each vehicle 200 in the traffic digital twin are acquired by the control unit 150, the process proceeds to step S603.

### (Step S603)

The control unit 150 of the information processing device 100 derives a grace coefficient for each vehicle 200 based on the longest prediction time and the collision grace time acquired in step S602 above. The grace coefficient is a parameter indicating the ratio of the collision grace time to the longest prediction time, and is calculated for each vehicle 200 using the following formula [1].

$$Grace coefficient = ( collision grace time ) / ( longest prediction time ) \qquad [ 1 ]$$

In the example in FIG. 7, if the longest prediction time for the vehicle A is “10 seconds” and the collision grace time for the vehicle A is “4 seconds”, the grace coefficient for the vehicle A is “0.4 (=4/10)”.

After the grace coefficient for each vehicle 200 is derived by the control unit 150, the process proceeds to step S604.

### (Step S604)

The control unit 150 of the information processing device 100 derives a collision occurrence probability between each vehicle 200 based on the object existence probability for each vehicle 200 acquired in step S601 above and the grace coefficient for each vehicle 200 derived in step S603 above. The collision occurrence probability is a parameter indicating the possibility of two vehicles 200 colliding as a probability, and is calculated for each combination of two vehicles 200 using the following formula [2].

$$Collision occurrence probability = ( object existence probability for first vehicle ) \times ( object existence probability for second vehicle ) \times ( 1 - grace coefficient for first vehicle ) \qquad [ 2 ]$$

In the example in FIG. 7, since the object existence probability for the vehicle A is “0.7”, the object existence probability for the vehicle C is “0.3”, and the grace coefficient for the vehicle A is “0.4”, the collision occurrence probability with the vehicle C for the vehicle A is

$$“ 0.126 ( = 0.7 \times 0.3 \times ( 1 - 0.4 ) ) ” .$$

After the collision occurrence probability between each vehicle 200 is derived by the control unit 150, the process proceeds to step S605.

### (Step S605)

The control unit 150 of the information processing device 100 derives a degree of influence upon a collision between each vehicle 200 based on the collision occurrence probability between each vehicle 200 derived in step S604 above and the relative speed between each vehicle 200. The degree of influence upon a collision is a parameter obtained by quantifying the influence of a collision between two vehicles 200, and is calculated for each combination of two vehicles 200 using the following formula [3]. The relative speed between each vehicle 200 is a vector quantity with direction information, and can be obtained based on vehicle data received from a target vehicle 200, etc.

$$Degree of influence upon collision = ( collision occurrence probability between vehicles ) \times ( relative speed between vehicles ) \qquad [ 3 ]$$

In the example in FIG. 7, if the relative speed of the vehicle C with respect to the vehicle A is +50 m/s, since the collision occurrence probability with the vehicle C for the vehicle A is “0.126”, the degree of influence upon a collision between the vehicle A and the vehicle C is 6.3 (=0.126×50).

After the degree of influence upon a collision between each vehicle 200 is derived by the control unit 150, the process proceeds to step S606.

### (Step S606)

The control unit 150 of the information processing device 100 determines a vehicle control value to be instructed to each vehicle 200, based on the degree of influence upon a collision between each vehicle 200 derived in step S605 above and the traffic conditions (surrounding conditions) around the vehicles 200. The vehicle control value is a value for performing control required in order to avoid collisions between the vehicles 200, and is determined according to the following formula [4] for specific vehicles 200 that require instructions.

$$Vehicle control value = ( acceleration / deceleration control value ) \times ( degree of influence upon collision ) \qquad [ 4 ]$$

In the example in FIG. 7, in order to avoid a collision between the vehicle A and the vehicle C, when instructing the vehicle A to stop, the vehicle control value is determined as “−0.63 m/s²” according to the following formula [5], and when instructing the vehicle C to pass, the vehicle control value is determined as “+0.315 m/s²” according to the following formula [6].

$$Vehicle control value for vehicle A = ( deceleration that enables stop at intersection start position by collision grace time ) \times ( degree of influence upon collision between vehicle A and vehicle C ) = - 10 m / {s}^{2} \times 6.3 \qquad [ 5 ]$$

$$Vehicle control value for vehicle C = ( acceleration that enables passing through intersection end position by collision grace time ) \times ( degree of influence upon collision between vehicle A and vehicle C ) = + 5 m / {s}^{2} \times 6.3 \qquad [ 6 ]$$

Examples of the traffic conditions (surrounding conditions of object) that are taken into account when determining the vehicle control value include infrastructure information, vehicle information, environmental information, etc. The infrastructure information includes “traffic rules” information including data such as traffic signs (stop, caution), traffic light information (light color, remaining time), and speed limits, “road structure” information including data such as road width, number of lanes, pedestrian crossings, road surface conditions, intersection location (distance to intersection), surrounding obstacles, and right/left turn lanes, “provisional/temporary” information including data such as construction and lane restrictions, etc. The vehicle information includes “movement” information including data such as position, probability of existence (on the digital twin), speed, and acceleration, “driver operation” information including data such as direction indicator status, steering wheel angle, navigation settings (destination/route), accelerator opening degree, and brake depressing force, “product status” information including data such as vehicle type (light/standard/large/other), vehicle type (general vehicle/emergency vehicle), powertrain type, and tire condition, “personality” information including data such as driving tendencies (habits, etc.) and driver response speed, etc. The environmental information includes “natural requirements” information including data such as weather, humidity, and temperature, “human requirements” information including data such as flow of people, whether or not events are being held, the positions of pedestrians and bicycles, the positions of other vehicles, and the occurrence of traffic congestion, etc.

After the vehicle control value to be instructed to each vehicle 200 is determined by the control unit 150, the vehicle control instruction process ends.

With the vehicle control instruction process, the vehicle control value to be instructed to each vehicle 200 is controlled based on the object existence probabilities, the traffic conditions, etc., assigned to the plurality of vehicles 200 included in the traffic digital twin, so that it is possible to effectively avoid a collision between these vehicles 200 and achieve smooth traffic flow.

The vehicle control value to be instructed to each vehicle 200 is determined so as to be appropriate in accordance with policies such as traffic rule compliance, prevention of dangerous events, and smooth traffic flow, taking into account the traffic rules, traffic conditions, etc., of the country or region where this control is performed. As for the range of each vehicle control value to be determined, the vehicle control values may be set uniformly to the safest content, or may be set individually for each country or region.

### SPECIFIC EXAMPLES

For example, in the example in FIG. 7, as for some cases where vehicle control values may be instructed to the vehicle A and the vehicle C (or the vehicle D) that may collide in future prediction, specific examples of traffic conditions that are used to determine these cases will be described.

### (Case 1)

Case where the vehicle A is instructed to decelerate but the vehicle C (or the vehicle D) is not instructed to decelerate.

### 1-1. Case of Using Object Existence Probability

The vehicle C having a lower existence probability than the vehicle A is considered to have a poorer communication quality with the information processing device 100 and to have a lower frequency of updating vehicle data than the vehicle A. That is, the vehicle A is more likely to receive instructions regarding vehicle control than the vehicle C. Therefore, in order to prioritize the prevention of dangerous events and more effectively reduce the possibility of collisions between the vehicles 200, the vehicle A having a higher existence probability is instructed to decelerate.

### 1-2. Case of Using Infrastructure Information (Priority Roads, Traffic Light Status)

If it is necessary to achieve smooth traffic flow, for example, if a road on which the vehicle C is traveling has priority over a road on which the vehicle A is traveling (priority road), or if a traffic light on the road on which the vehicle C is traveling is green, the vehicle A is instructed to decelerate, and the vehicle C is instructed to maintain the speed or accelerate.

### (Case 2)

Case where the vehicle A is not instructed to decelerate but the vehicle C (or the vehicle D) is instructed to decelerate.

### 2-1. Case of Using Vehicle Information (Vehicle Body Information, Operation Information)

If the vehicle A is an emergency vehicle and is predicted to enter an intersection, the vehicle C is instructed to decelerate in order to give priority to the traveling of the vehicle A. Furthermore, if the vehicle A is predicted to turn right based on a driver's operation (direction indicator or the like), the vehicle D is also instructed to decelerate.

### 2-2. Case of Using Infrastructure Information (Road Information) and Vehicle Information (Position)

Even if a road on which the vehicle C is traveling is a priority road and the vehicle A is a general vehicle, if the vehicle A has already entered an intersection, the vehicle C (also the vehicle D, depending on the traveling direction) is instructed to decelerate in order to prioritize the prevention of dangerous events and reduce the possibility of collisions between the vehicles 200.

### 2-3. Case of Using Traffic Information (Vehicle Stop Time)

When there are many vehicles stopped behind the vehicle A and the vehicle A itself has also been stopped for a long time, even if a road on which the vehicle C is traveling is a priority road, the vehicle C (also the vehicle D, depending on the traveling direction) is temporarily instructed to decelerate in order to prioritize the achievement of smooth traffic flow.

### 2-4. Case of Using Personality Information

When there are many vehicles stopped behind the vehicle A and the vehicle A itself has been stopped for a long time, if emotion estimation is performed based on personality information of the driver of each vehicle and the driver of the vehicle A is feeling a lot of stress, even if a road on which the vehicle C is traveling is a priority road, the vehicle C (also the vehicle D, depending on the traveling direction) is temporarily instructed to decelerate in order to prevent the driver of the vehicle A from becoming distracted due to stress. However, if it is better to make the vehicle A wait when the personality information of the drivers of the vehicle C and the vehicle D is taken into account, a different response may be considered.

### Action, Effect, Etc

As described above, in the information processing device 100 according to the embodiment of the present disclosure, when the completeness of the traffic digital twin is low, an object existence probability in an area where there is no direct object data and the existence of objects is undetermined in the traffic digital twin is determined based on indirect object data that can be acquired from objects in other areas where the existence of objects is determined. Then, the information processing device 100 complements the information of the undetermined area by taking into account or reflecting the determined object existence probability in the undetermined area, in the construction of the traffic digital twin. Accordingly, the completeness of the traffic digital twin can be improved.

In addition, in the information processing device 100 according to the one embodiment of the present disclosure, information regarding collisions is calculated based on the existence probabilities, the traffic conditions, etc., assigned to the plurality of objects 200 included in the traffic digital twin, and control of each object 200 is instructed based on this calculated information. Accordingly, it becomes possible to perform vehicle control that effectively reflects the object existence probabilities, so that it is possible to achieve smooth traffic flow while prioritizing the prevention of dangerous events such as avoidance of collisions between the objects 200.

Although the embodiment of the present disclosure has been described above, the present disclosure can be considered not only as an information processing device, but also as a method executed by an information processing device including a processor and a memory, a program for executing this method, a non-transitory computer-readable storage medium having the program stored therein, and a system including an information processing device and a vehicle.

### INDUSTRIAL APPLICABILITY

The present disclosure is useful for the case where improvement of the completeness of a traffic digital twin in an information processing device is desired, etc.

### DESCRIPTION OF THE REFERENCE CHARACTERS

10 digital twin system
100 information processing device
110 communication unit
120 processing unit
130 digital twin
140 determination unit
150 control unit
200 object (vehicle)

1. An information processing device configured to control communication with a plurality of objects, the information processing device comprising:
a communication unit configured to acquire object data from the plurality of objects through the communication;
a processing unit configured to construct a traffic digital twin synchronized in time with a real space, in a virtual space, based on the object data acquired by the communication unit; and
a determination unit configured to determine an object existence probability in an undetermined area where there is no object data in the traffic digital twin, based on the object data around the undetermined area, and notify the processing unit of the determined object existence probability in the undetermined area.

2. The information processing device according to claim 1, wherein, if completeness of the traffic digital twin is equal to or lower than a predetermined threshold value, the determination unit determines the object existence probability in the undetermined area in the traffic digital twin.

3. The information processing device according to claim 2, wherein
the objects are vehicles, and
the determination unit determines the object existence probability in the undetermined area, based on an inter-vehicle distance between vehicles located in front of and behind the undetermined area and a time for which the inter-vehicle distance is maintained.

4. The information processing device according to claim 2, wherein
the objects are vehicles, and
the determination unit determines the object existence probability in the undetermined area, based on a distance from a stop line to a vehicle, located behind the undetermined area, when the vehicle stops at a specific location including an intersection or a railroad crossing.

5. The information processing device according to claim 2, wherein
the objects are vehicles, and
the determination unit determines the object existence probability in the undetermined area, based on the number of vehicles traveling while avoiding the undetermined area and a time for which avoidance action by vehicles continues.

6. The information processing device according to claim 1, further comprising a control unit configured to derive a probability of a collision occurring between the plurality of objects, based on the object existence probability of the traffic digital twin, and determine control values to be instructed to the plurality of objects, based on the probability of the collision occurring between the plurality of objects.

7. The information processing device according to claim 6, wherein the control unit derives the probability of the collision occurring between the plurality of objects, based on a longest time for which one or more applications that provide services to the objects can predict behavior of each object, and a time predicted to be taken until two said objects collide with each other, by the one or more applications.

8. The information processing device according to claim 7, wherein the control unit derives a degree of influence upon a collision between the plurality of objects, based on the probability of the collision occurring between the plurality of objects and relative speeds between the plurality of objects.

9. The information processing device according to claim 8, wherein the control unit determines the control values to be instructed to the plurality of objects, based on the degree of influence upon the collision between the plurality of objects and surrounding conditions of the objects.

10. A method executed by a computer of an information processing device configured to control communication with a plurality of objects, the method comprising:
a step of acquiring object data from the plurality of objects through the communication;
a step of constructing a traffic digital twin synchronized in time with a real space, in a virtual space, based on the acquired object data;
a step of determining an object existence probability in an undetermined area where there is no object data in the traffic digital twin, based on the object data around the undetermined area; and
a step of reflecting the determined object existence probability in the undetermined area, in construction of the traffic digital twin.

11. A program executed by a computer of an information processing device configured to control communication with a plurality of objects, the program comprising:
a step of acquiring object data from the plurality of objects through the communication;
a step of constructing a traffic digital twin synchronized in time with a real space, in a virtual space, based on the acquired object data;
a step of determining an object existence probability in an undetermined area where there is no object data in the traffic digital twin, based on the object data around the undetermined area; and
a step of reflecting the determined object existence probability in the undetermined area, in construction of the traffic digital twin.
